(19) United States
(12) Patent Application Publication
(10) Pub. No.: US 2026/0070155 A1
(43) Pub. Date: Mar. 12, 2026

(54) METHODS AND TOOLS FOR CUTTING FUEL CELL ELECTRODES

(71) Applicant: GM Global Technology Operations LLC, Detroit, MI (US)

(72) Inventor: Thomas D. Bronchetti, Auburn Hills, MI (US)

(73) Assignee: GM Global Technology Operations LLC, Detroit, MI (US)

(21) Appl. No.: 18/882,502

(22) Filed: Sep. 11, 2024

(51) Int. Cl. B23K 26/38; B23K 26/08; B23K 26/16; B23K 26/402; B23K 37/04; B23K 101/36; H01M 4/88

(52) U.S. Cl. CPC B23K 26/38; B23K 26/0869; B23K 26/16; B23K 26/402; B23K 37/0408; H01M 4/8875; B23K 2101/36

(57) ABSTRACT

A cutting tool includes a first vacuum manifold, a second vacuum manifold separated from the first vacuum manifold by a gap, a laser, and an actuator. The actuator is configured to move the laser along the gap for cutting a material held down by, and substantially flat to, the cutting tool by the first and second vacuum manifolds. The laser is configured to, when moved along the gap by the actuator, cut through the material without causing substantive contamination of the material by any second material of the cutting tool.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to methods and tools for laser cutting fuel cell electrodes from a rolled process electrode into discrete sheets for forming fuel cell membrane electrode assemblies (MEAs) and battery assemblies without the need for a backing substrate.

Some laser cutting systems require that a substrate, that is to be cut, be held down (e.g., by a vacuum table) during cutting. Vacuum holding devices are typically made of steel that may be damaged during a laser cutting process. Such cutting of a vacuum holding device may release potentially damaging particulate onto the underside of the substrate. Therefore, there is a need for improved methods and tools for cutting a substrate.

### SUMMARY

One aspect of the disclosure provides a cutting tool including a first vacuum manifold, a second vacuum manifold separated from the first vacuum manifold by a gap, a laser, and an actuator. The actuator is configured to move the laser along the gap for cutting a material held down by, and substantially flat to, the cutting tool by the first and second vacuum manifolds. The laser is configured to, when moved along the gap by the actuator, cut through the material without causing substantive contamination of the material by any second material of the cutting tool.

Implementations of the disclosure may include one or more of the following optional features. In some implementations, the actuator includes a belt configured to move the laser substantially parallel to the gap. In some examples, the laser is configured to have a cutting depth, and the gap has a depth that is at least the cutting depth minus a thickness of the material. In some implementations, the gap has a width that is greater than a width of a laser beam emitted by the laser. In some examples, the laser is configured to, when moved along the gap by the actuator, cut through the material without causing substantive heating of the cutting tool.

In some examples, the material includes a porous carbon material for forming a fuel cell electrode that can be contaminated by the second material of the cutting tool. In some implementations, the cutting tool also includes a plate, wherein the first and second vacuum manifolds are mounted to the plate, and one or more vacuums for drawing air through the first and second vacuum manifolds for securing the material to the cutting tool.

In some implementations, the cutting tool also includes a third vacuum manifold separated from the second vacuum manifold by a second gap, and a positioner configured to move the laser to the second gap. The actuator is configured to move the laser along the second gap for cutting the material held down to the cutting tool, and the laser is configured to, when being moved along the second gap by the actuator, cut through the material without causing substantive contamination of the material by any second material of the cutting tool. In some examples, the gap is substantially parallel to the second gap.

In some examples, the cutting tool includes a plurality of vacuum manifolds including the first and second vacuum manifolds. Each of the plurality of vacuum manifolds is separated from an adjacent vacuum manifold by a corresponding gap, and a pair of the corresponding gaps represents an intended shape of a part to be cut from the material offset from another pair of the corresponding gaps.

Another aspect of the disclosure provides a computer-implemented method executed by data processing hardware that causes the data processing hardware to perform operations. The operations include activating a vacuum to secure a material to a cutting tool, the cutting tool including a first vacuum manifold and a second vacuum manifold separated from the first vacuum manifold by a gap, activating a laser, and moving the laser, while the laser is activated, along the gap to cut the material secured to the cutting tool, wherein moving the laser to cut the material, cuts through the material without causing substantive contamination of the material by any second material of the cutting tool.

Implementations of the disclosure may include one or more of the following optional features. In some implementations, moving the laser includes activating a belt configured to move the laser substantially parallel to the gap. In some examples, the laser is configured to have a cutting depth, and the gap has a depth that is at least the cutting depth minus a thickness of the material. In some implementations, the gap has a width that is greater than a width of a laser beam emitted by the laser. In some examples, moving the laser along the gap causes the laser to cut through the material without causing substantive heating of the cutting tool.

In some examples, the material includes a porous carbon material for forming a fuel cell electrode that can be contaminated by the second material of the cutting tool. In some implementations, the cut material forms a first fuel cell electrode, and the operations also include assembling the first fuel cell electrode with one or more additional fuel cell electrodes to form a membrane electrode assembly of a fuel cell.

In some implementations, the cutting tool includes a third vacuum manifold separated from the second vacuum manifold by a second gap, and the operations also include deactivating the laser, moving the laser, while deactivated, to the second gap, re-activating the laser, and moving the laser, while the laser is activated, along the second gap to cut the material secured to the cutting tool. In some examples, the gap is substantially parallel to the second gap.

In some examples, the cutting tool includes a plurality of vacuum manifolds including the first and second vacuum manifolds. Each of the plurality of vacuum manifolds is separated from an adjacent vacuum manifold by a corresponding gap. The operations also include selecting one or more of the corresponding gaps corresponding to an intended shape of a part to be cut from the material and, for each particular gap of the selected one or more corresponding gaps, deactivating the laser, moving the laser, while deactivated, to the particular gap, re-activating the laser, and moving the laser, while the laser is activated, along the particular gap to cut the material secured to the cutting tool.

Another aspect of the disclosure provides a cutting tool including first and second vacuum manifolds, a plate, one or more vacuums, a laser, a positioner, and an actuator. The second vacuum manifold is separated from the first vacuum manifold by a gap. The first and second vacuum manifolds are mounted to the plate. The one or more vacuums are configured to draw air through the first and second vacuum manifolds for securing a material to the cutting tool. The laser is configured to have a cutting depth, wherein the gap has a depth that is at least the cutting depth minus a thickness of the material, and a width that is greater than a width of a laser beam emitted by the laser. The positioner is configured to move the laser to the gap, and the actuator is configured to move the laser along and substantially parallel to the gap for cutting material held down by, and substantially flat to, the cutting tool by the first and second vacuum manifolds. The laser is configured to, when moved along the gap by the actuator, cut through the material without causing substantive contamination of the material by any second material of the cutting tool.

### BRIEF DESCRIPTION OF THE DRAWINGS

The drawings described herein are for illustrative purposes only of selected configurations and are not intended to limit the scope of the present disclosure.

FIG. 1 is a schematic view of an example cutting tool for cutting fuel cell electrodes.

FIG. 2 illustrates example fuel cell electrodes cut using the example cutting tool of FIG. 1.

FIG. 3 is a flow chart of an example arrangement of operations for a method of cutting fuel cell electrodes.

FIG. 4 is a schematic view of an example computing device that may be used to implement the systems and methods described herein.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an application specific integrated circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA or an ASIC. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

The present disclosure relates generally to methods and tools for laser cutting fuel cell electrodes from a rolled process electrode into discrete sheets for forming fuel cell membrane electrode assemblies (MEAs) and battery assemblies without the need for a backing substrate. Such fuel cell electrodes, fuel cell MEAs, and battery assemblies may be used to power vehicles (e.g., cars, trucks, trains, planes, bicycles, etc.) and non-vehicular devices and systems.

Some laser cutting systems require that a substrate, that is to be cut, be held down (e.g., by a vacuum table) during cutting. Vacuum holding devices are typically made of steel that may be damaged during a laser cutting process. Such cutting of a vacuum holding device may release potentially damaging particulate onto the underside of the substrate. Such particulate may be especially problematic when a property of the substrate may be changed by the particulate. For example, when a porous carbon material is laser cut for forming a fuel cell electrode, the porous carbon material may be contaminated by such particulate. A fuel cell containing a contaminated fuel cell electrode may not operate as intended. Therefore, there is a need for improved methods and tools for cutting fuel cell electrodes. Implementations disclosed herein eliminate the need for supporting a cut area with a backer material, which improves the quality of the cuts and reduces the possibility of degrading materials being burned into an electrode.

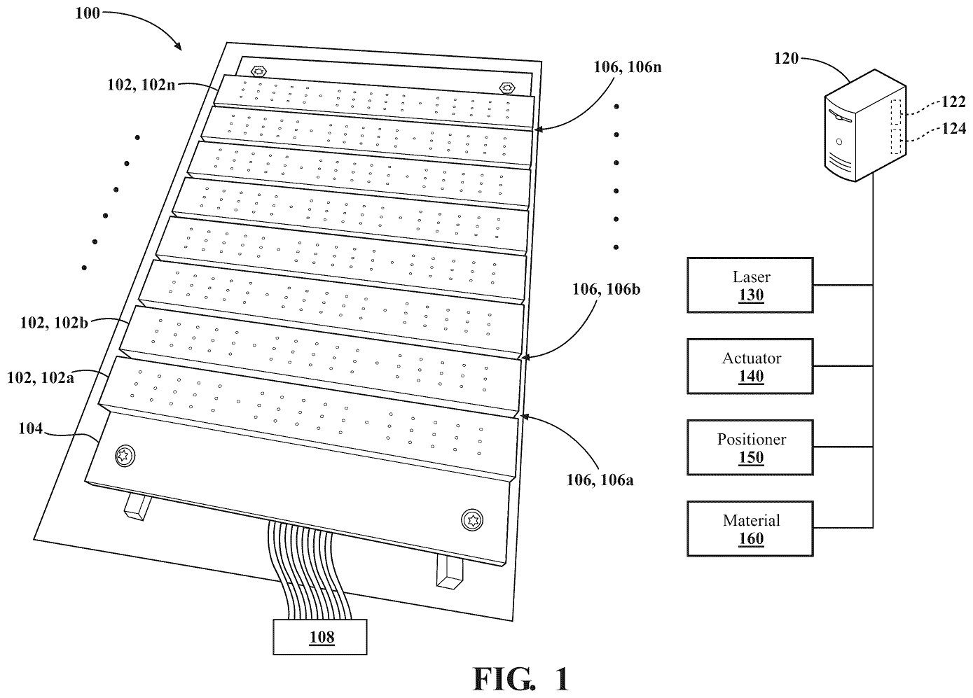

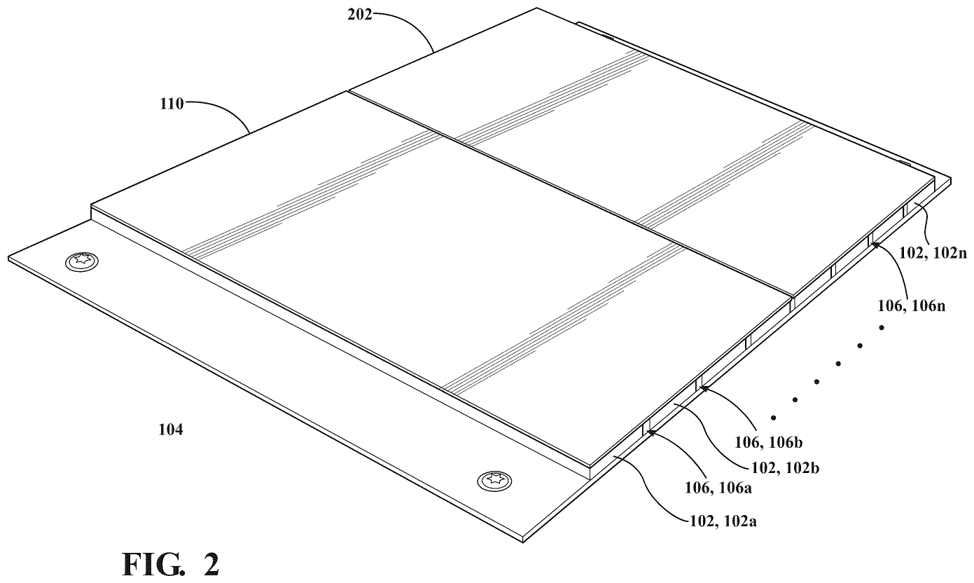

FIG. 1 is a schematic view of an example cutting tool 100 for cutting fuel cell electrodes 202 (see FIG. 2) from a rolled process electrode material 110. The cutting tool 100 includes a plurality of vacuum manifolds 102, 102a-n that are mounted to a supporting surface or plate 104. Here, each of the plurality of vacuum manifolds 102 is separated from an adjacent vacuum manifold 102 by a corresponding gap 106, 106a-n. For example, vacuum manifolds 102a and 102b are separated by a corresponding gap 106a. In the illustrated example, the gaps 106 are substantially parallel and may correspond to the cutting of different lengths of the material 110. However, the gaps 106 may be arranged in other patterns (e.g., perpendicularly) for cutting the material 110 into other shapes.

In some implementations, the gaps 106 are spaced to allow skip cutting of the material 110 such that defective areas of the material 110 may be discarded. That is, a pair of the gaps 106 that represent an intended shape of a part to be cut from the material 110 is offset from another pair of the gaps 106. Here, each pair of the gaps 106 can be used to cut a same shape of the material 110. For example, the gaps 106 may be spaced X millimeters apart while the material 110 is to be cut into lengths of X*Y millimeters.

The cutting tool 100 also includes one or more vacuums 108 for drawing air through the vacuum manifolds 102 for securing the material 110 (see FIG. 2) that is to be cut to the cutting tool 100. Here, the material 110 includes a porous carbon material for forming a fuel cell electrode that can be contaminated by a material of the cutting tool 100. In some examples, the material 110 is taken from a roll of porous carbon material, and the vacuum manifolds 102 are configured, when the vacuums 108 are active, to secure the material 110 to, and substantially flat to, the cutting tool 100.

FIG. 2 illustrates an example fuel cell electrode 202 that has been cut from material 110 by the example cutting tool of FIG. 1. As shown, the material 110 is secured to the cutting tool by the vacuum manifolds 102.

Returning to FIG. 1, in the illustrated example, a computing system 120 may selectively activate the vacuum(s) 108 for securing the material 110 to the cutting tool 100, and selectively deactivate the vacuum(s) 108 for releasing the material 110 from the cutting tool 100. The computing system 120 may correspond to any type of computing device, such as a process controller. The computing system 120 includes data processing hardware 122, and memory hardware 124 in communication with the data processing hardware 122. Here, the memory hardware 124 stores instructions that, when executed by the data processing hardware 122, cause the data processing hardware 122 to perform one or more operations, such as those disclosed herein.

For cutting material 110, the cutting tool 100 includes a laser 130, an actuator 140, and a positioner 150 that may also be selectively controlled by the computing system 120. The laser 130 is configured to emit a laser beam for cutting the material 110. Here, the laser 130 is configured, under control of the computing system 120, to emit a laser beam having a cutting depth that is at least the thickness of the material 110, and having a width that is less than a width of the gaps 106 (e.g., two millimeters). In some examples, the gaps 106 have a depth that is at least the cutting depth of the laser beam minus a thickness of the material 110.

The actuator 140 is configured to, under control of the computing system 120, move the laser 130 along a gap 106 for cutting material 110 held down by, and substantially flat to, the cutting tool 100 by one or more of the vacuum manifolds 102. Here, the laser 130, when activated, is configured to, when moved along a gap 106 by the actuator 140, cut through the material 110 without causing substantive contamination of the material 110 by any material of the cutting tool 100. For example, to ensure that any contaminating material 110 has a dimension of less than 50 microns. For example, without causing substantive heating of the cutting tool 100, such that substantially no material of the cutting tool 100 is released. In some implementations, the cutting tool 100 is a vacuum belt cutter, and the actuator 140 includes a belt configured to move the laser 130 substantially parallel to a gap 106.

The positioner 150 is configured to, under control of the computing system 120, move the laser 130 between the gaps 106. For example, to move the laser 130 from a first gap 106a to a second gap 106b.

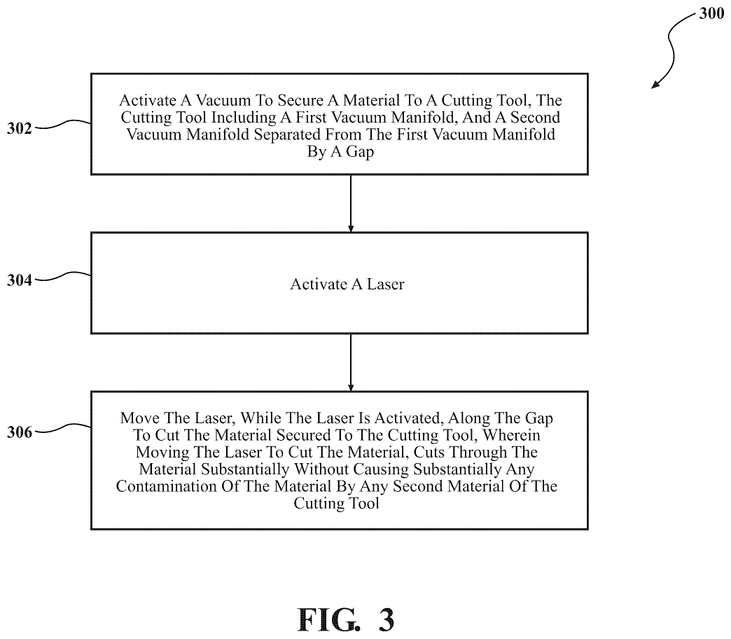

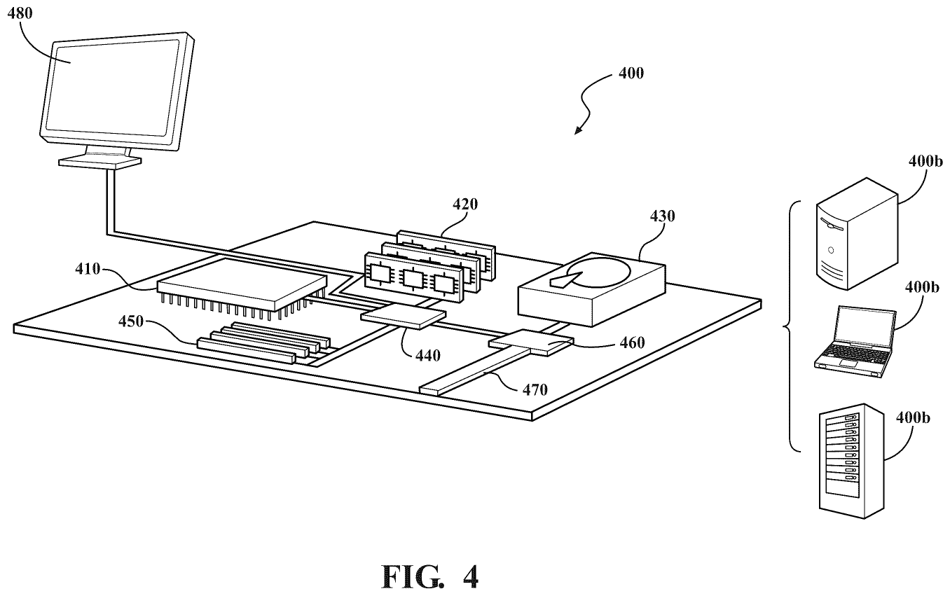

FIG. 3 is a flowchart of an exemplary arrangement of operations for a computer-implemented method 300 for cutting fuel cell electrodes. The operations may be performed by data processing hardware 410 (FIG. 4) (e.g., the data processing hardware 122 of the computing system 120) based on executing instructions stored on memory hardware 420 (e.g., the memory hardware 124 of the computing system 120).

At operation 302, the method 300 includes activating the vacuum 108 to secure material 110 to the cutting tool 100. The cutting tool 100 including a first vacuum manifold 102a, and a second vacuum manifold 102b separated from the first vacuum 102a manifold by a gap 106a. At operation 304, the method 300 includes activating the laser 130. At operation 306, the method 300 includes moving the laser 130, while the laser 130 is activated, along the gap 106a to cut the material 110 secured to the cutting tool 100, wherein moving the laser 130 to cut the material 110, cuts through the material 110 without causing substantive contamination of the material 110 by any second material of the cutting tool 100.

FIG. 4 is schematic view of an example computing device 400 that may be used to implement the systems and methods described herein. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 122, memory 420 (i.e., memory hardware) that can be used to implement the memory hardware 124, a storage device 430 (i.e., memory hardware) that can be used to implement the memory hardware 124, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A cutting tool comprising:
a first vacuum manifold;
a second vacuum manifold separated from the first vacuum manifold by a gap;
a laser; and
an actuator configured to move the laser along the gap for cutting a material held down by, and substantially flat to, the cutting tool by the first and second vacuum manifolds,
wherein the laser is configured to, when moved along the gap by the actuator, cut through the material without causing substantive contamination of the material by any second material of the cutting tool.

2. The cutting tool of claim 1, wherein the actuator comprises a belt configured to move the laser substantially parallel to the gap.

3. The cutting tool of claim 1, wherein:
the laser is configured to have a cutting depth; and
the gap has a depth that is at least the cutting depth minus a thickness of the material.

4. The cutting tool of claim 1, wherein the gap has a width that is greater than a width of a laser beam emitted by the laser.

5. The cutting tool of claim 1, wherein the laser is configured to, when moved along the gap by the actuator, cut through the material without causing substantive heating of the cutting tool.

6. The cutting tool of claim 1, wherein the material comprises a porous carbon material for forming a fuel cell electrode that can be contaminated by the second material of the cutting tool.

7. The cutting tool of claim 1, further comprising:
a plate, wherein the first and second vacuum manifolds are mounted to the plate; and
one or more vacuums for drawing air through the first and second vacuum manifolds for securing the material to the cutting tool.

8. The cutting tool of claim 1, further comprising
a third vacuum manifold separated from the second vacuum manifold by a second gap; and
a positioner configured to move the laser to the second gap,
wherein the actuator is further configured to move the laser along the second gap for cutting the material held down to the cutting tool, and
wherein the laser is configured to, when being moved along the second gap by the actuator, cut through the material without causing substantive contamination of the material by any second material of the cutting tool.

9. The cutting tool of claim 8, wherein the gap is substantially parallel to the second gap.

10. The cutting tool of claim 1, wherein:
the cutting tool comprises a plurality of vacuum manifolds including the first and second vacuum manifolds, each of the plurality of vacuum manifolds is separated from an adjacent vacuum manifold by a corresponding gap; and
a pair of the corresponding gaps representing an intended shape of a part to be cut from the material offset from another pair of the corresponding gaps.

11. A computer-implemented method executed by data processing hardware that causes the data processing hardware to perform operations comprising:
activating a vacuum to secure a material to a cutting tool, the cutting tool comprising a first vacuum manifold, and a second vacuum manifold separated from the first vacuum manifold by a gap;
activating a laser; and
moving the laser, while the laser is activated, along the gap to cut the material secured to the cutting tool, wherein moving the laser to cut the material, cuts through the material without causing substantive contamination of the material by any second material of the cutting tool.

12. The computer-implemented method of claim 11, wherein moving the laser comprises activating a belt configured to move the laser substantially parallel to the gap.

13. The computer-implemented method of claim 11, wherein:
the laser is configured to have a cutting depth; and
the gap has a depth that is at least the cutting depth minus a thickness of the material.

14. The computer-implemented method of claim 11, wherein the gap has a width that is greater than a width of a laser beam emitted by the laser.

15. The computer-implemented method of claim 11, wherein moving the laser along the gap causes the laser to cut through the material without causing substantive heating of the cutting tool.

16. The computer-implemented method of claim 11, wherein the material comprises a porous carbon material for forming a fuel cell electrode that can be contaminated by the second material of the cutting tool.

17. The computer-implemented method of claim 11, wherein:
the cut material forms a first fuel cell electrode; and
the operations further comprise assembling the first fuel cell electrode with one or more additional fuel cell electrodes to form a membrane electrode assembly of a fuel cell.

18. The computer-implemented method of claim 11, wherein:
the cutting tool comprises a third vacuum manifold separated from the second vacuum manifold by a second gap; and
the operations further comprise:
deactivating the laser;
moving the laser, while deactivated, to the second gap;
re-activating the laser; and
moving the laser, while the laser is activated, along the second gap to cut the material secured to the cutting tool.

19. The computer-implemented method of claim 11, wherein:
the cutting tool comprising a plurality of vacuum manifolds including the first and second vacuum manifolds, each of the plurality of vacuum manifolds separated from an adjacent vacuum manifold by a corresponding gap; and
the operations further comprise:
selecting one or more of the corresponding gaps corresponding to an intended shape of a part to be cut from the material; and
for each particular gap of the selected one or more corresponding gaps:
deactivating the laser;
moving the laser, while deactivated, to the particular gap;
re-activating the laser; and
moving the laser, while the laser is activated, along the particular gap to cut the material secured to the cutting tool.

20. A cutting tool comprising:
a first vacuum manifold;
a second vacuum manifold separated from the first vacuum manifold by a gap;
a plate, wherein the first and second vacuum manifolds are mounted to the plate; and
one or more vacuums for drawing air through the first and second vacuum manifolds for securing a material to the cutting tool;
a laser configured to have a cutting depth, wherein the gap has a depth that is at least the cutting depth minus a thickness of the material, and a width that is greater than a width of a laser beam emitted by the laser;
a positioner configured to move the laser to the gap; and
an actuator configured to move the laser along and substantially parallel to the gap for cutting material held down by, and substantially flat to, the cutting tool by the first and second vacuum manifolds,
wherein the laser is configured to, when moved along the gap by the actuator, cut through the material without causing substantive contamination of the material by any second material of the cutting tool.
